(19) United States
(12) Patent Application Publication
(10) Pub. No.: US 2006/0066213 A1
(43) Pub. Date: Mar. 30, 2006

(54) Flat-type fluorescent lamp and liquid crystal display apparatus having the same

(75) Inventors: Hyoung-Joo Kim, Uiwang-si (KR); Min-Gyu Kim, Seoul (KR); Nam-Ok Kwon, Seoul (KR); Sang-Yu Lee, Yongin-si (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/192,737

(22) Filed: Jul. 29, 2005

(30) Foreign Application Priority Data
Sep. 24, 2004 (KR) 10-2004-77034

(51) Int. Cl. H01J 1/62

(52) U.S. Cl. 313/493

(57) ABSTRACT

In a flat-type fluorescent lamp and a liquid crystal display apparatus, the flat-type fluorescent lamp includes a lamp body having an inner space divided into a plurality of discharge channels, a venting member coupled to the lamp body, and a first external electrode formed on the lamp body. The first external electrode has an opening through which the venting member is exposed. Thus, an electric field between a bottom chassis and the external electrode is made uniform, thereby improving brightness uniformity of the flat-type fluorescent lamp.

### CROSS-REFERENCE TO RELATED APPLICATION

This application relies for priority upon Korean Patent Application No. 2004-77034 filed on Sep. 24, 2004, the content of which is herein incorporated by reference in its entirety.

### BACKGROUND OF THE INVENTION

1. Field of the Invention

The present invention relates to a flat-type fluorescent lamp and a liquid crystal display apparatus having the same. More particularly, the present invention relates to a flat-type fluorescent lamp that functions as a surface light source and a liquid crystal display apparatus having the same.

2. Description of the Related Art

A liquid crystal display apparatus, which is a type of flat panel display apparatus, displays an image using liquid crystals. Liquid crystal display apparatuses have various desirable characteristics, such as small size, low power consumption, light weight, etc. and are thus widely used in various electronic instruments.

A liquid crystal display apparatus requires a light source because a liquid crystal display panel for the liquid crystal display apparatus is a light-receiving element that does not emit light on its own.

As the light source for the liquid crystal display apparatus, a cold cathode fluorescent lamp having a tubular shape is frequently used. However, in a large-scale liquid crystal display apparatus, the number of the cold cathode fluorescent lamp increases so that optical properties such as brightness uniformity, etc. are deteriorated and the manufacturing cost is higher.

Recently, in order to reduce the manufacturing cost and enhance the brightness uniformity, a flat-type fluorescent lamp emitting a planar light has been developed. The flat-type fluorescent lamp generally includes a lamp body having an inner space divided into a plurality of discharge channels and an electrode applying a discharge voltage to the lamp body. The discharge channels are internally connected to each other to maintain a uniform discharge gas level throughout the discharge channels. When the discharge voltage from an inverter is applied to the electrode, a plasma discharge is generated in each of the discharge channels due to the discharge voltage. A fluorescent film inside the flat-type fluorescent lamp is excited by the ultraviolet radiation produced by the plasma discharge and generates visible light.

The flat-type fluorescent lamp has a venting tip attached to the lamp body to vent the air inside the inner space and inject discharge gas into the inner space of the lamp body. Also, the electrode is formed over an outer surface of the lamp body. When the flat-type fluorescent lamp is received into a bottom chassis formed of metal, an electric field forms between the electrode and the bottom chassis. The electric field in the area in which the venting tip is formed is stronger than that in an area in which the venting tip is not formed. Due to the different electric field strengths within the lamp, brightness uniformity and reliability of the flat-type fluorescent lamp are deteriorated.

### SUMMARY OF THE INVENTION

The present invention provides a flat-type fluorescent lamp having improved brightness uniformity and reliability.

The present invention also provides a liquid crystal display apparatus having the above flat-type fluorescent lamp.

In one aspect of the present invention, a flat-type fluorescent lamp includes a lamp body, a venting tip and an external electrode. The lamp body has an inner space divided into a plurality of discharge channels. The venting member is formed on the lamp body. The first external electrode is formed on the lamp body and has an opening through which the venting member is exposed.

The first external electrode may have a substantially uniform width except for an area at which the opening is formed. The first external electrode may further include a compensation electrode extending in a first direction that is substantially perpendicular to the second direction in which the first external electrode extends.

In another aspect of the present invention, a liquid crystal display apparatus includes a flat-type fluorescent lamp, a bottom chassis, a liquid crystal display panel and an inverter.

The flat-type fluorescent lamp has a lamp body having an inner space divided into a plurality of discharge channels, a venting member coupled to the lamp body and a first external electrode formed on the lamp body, the first external electrode having an opening through which the venting member is exposed. The bottom chassis receives the flat-type fluorescent lamp. The liquid crystal display panel displays an image using light emitted from the flat-type fluorescent lamp. The inverter generates a discharge voltage to drive the flat-type fluorescent lamp.

The bottom chassis may have a protrusion corresponding to the venting member, which protrudes outward.

According to the above, since a portion of the external electrode near the venting tip is removed. As a result, the electric field between the bottom chassis and the external electrode is made uniform, thereby improving the brightness uniformity of the flat-type fluorescent lamp.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view showing a rear face of a flat-type fluorescent lamp according to an exemplary embodiment of the present invention;

FIG. 2 is a perspective view showing the flat-type fluorescent lamp of FIG. 1;

FIG. 3 is a cross-sectional view along a line I-I′ of FIG. 2;

FIG. 4 is a partially enlarged view of a portion “A” of FIG. 3;

FIG. 5 is a plan view showing a flat-type fluorescent lamp according to another exemplary embodiment of the present invention;

FIG. 6 is a perspective view showing a flat-type fluorescent lamp according to another exemplary embodiment of the present invention;

FIG. 7 is a cross-sectional view taken along a line II-II′ of FIG. 6;

FIG. 8 is an exploded perspective view showing a liquid crystal display apparatus according to an exemplary embodiment of the present invention; and

FIG. 9 is a cross-sectional view showing the liquid crystal display apparatus of FIG. 8.

### DESCRIPTION OF THE EMBODIMENTS

Hereinafter, the present invention will be explained in detail with reference to the accompanying drawings.

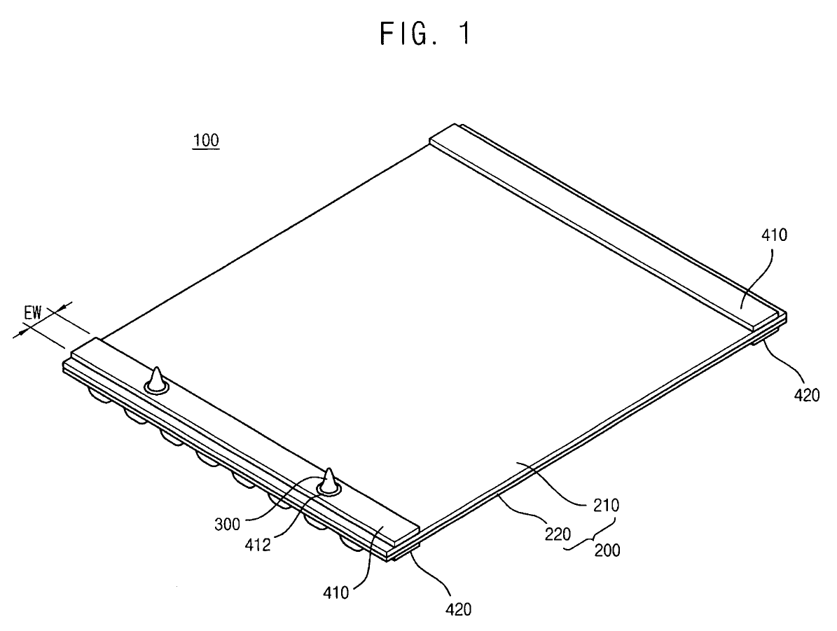

FIG. 1 is a perspective view showing a rear face of a flat-type fluorescent lamp according to an exemplary embodiment of the present invention.

Referring to FIG. 1, a flat-type fluorescent lamp 100 has a lamp body 200, a venting tip 300 and a first external electrode 410.

The lamp body 200 has an inner space divided into a plurality of discharge channels and generates light in response to a discharge voltage that is applied to the lamp body 200. The lamp body 200 has a first substrate 210 and a second substrate 220 that is combined with the first substrate 210 to provide the inner space.

The venting tip 300 is attached to an outer face of the lamp body 200. For example, the venting tip 300 is attached to an outer face of the first substrate 210 or to an outer face of the second substrate 220. In the present embodiment, the flat-type fluorescent lamp 100 has two venting tips 300. The venting tip 300 is formed in the non-effective light emitting area where the first external electrode 410 is located and where light is not transmitted. The venting tip 300 is used as a pathway through which the air in the inner space of the lamp body 200 is vented or discharge gas is injected into the inner space.

The first external electrode 410 is formed on the outer face of the lamp body 200. Particularly, the first external electrode 410 is formed in a predetermined area of the outer face of the lamp body 200 where the venting tip 300 is formed. The first external electrode 410 is formed along two edges of the first substrate 210. The first external electrode 410 has an opening 412 to expose the venting tip 300. When the first external electrode 410 is formed on the outer face of the first substrate 210, the first external electrode 410 is formed along an edge of the first substrate 210 except the area in which the venting tip 300 is formed. An opening 412 is formed through the first external electrode 410 to accommodate the venting tip 300. Except for the openings 412, the first external electrode 410 has a constant electrode width EW.

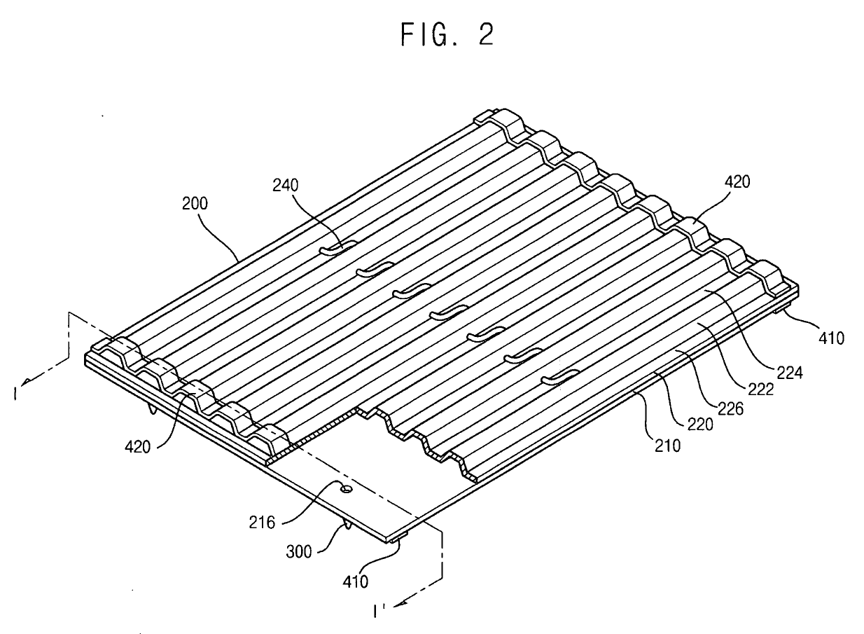

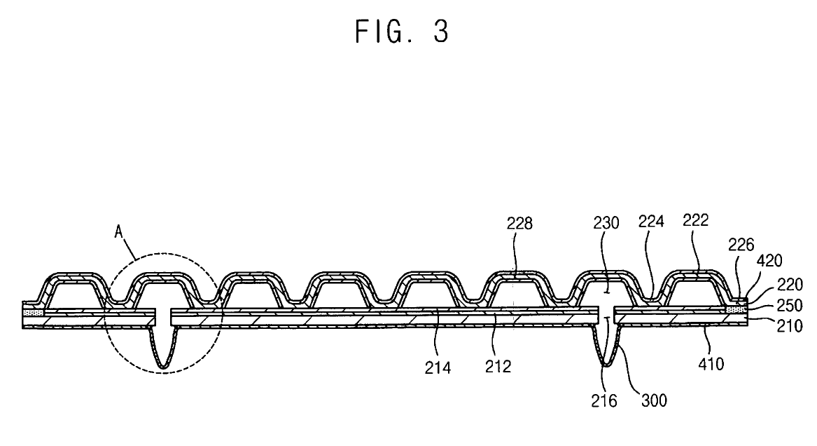

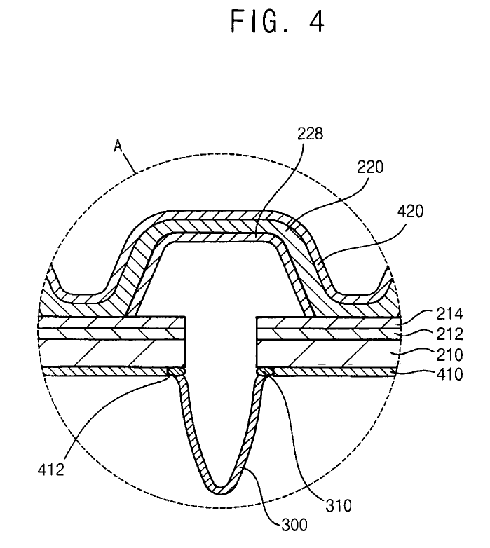

FIG. 2 is a perspective view showing the flat-type fluorescent lamp of FIG. 1, FIG. 3 is a cross-sectional view along a line I-I′ of FIG. 2, and FIG. 4 is a partially enlarged view of a portion “A” of FIG. 3. Referring to FIGS. 2 to 4, the flat-type fluorescent lamp 100 has the lamp body 200 having the inner space divided into the discharge channels 230, the venting tip 300 attached to the lamp body 200, and the first external electrode 410 formed on the outer face of the lamp body 200.

The lamp body 200 has the first substrate 210 and the second substrate 220 that is combined with the first substrate 210 to provide the discharge channels 230. In the present embodiment, each of the first and second substrates 210 and 220 is a transparent glass substrate that transmits visible light. The first and second substrates 210 and 220 may further include a blocking material so as to contain an ultraviolet light generated at the discharge channels 230 therein.

The first substrate 210 has a generally rectangular plate shape. The first substrate 210 has a venting hole 216 formed at a position corresponding to the venting tip 300.

The second substrate 220, which is spaced apart from the first substrate 210 by an adhesive 250, has a plurality of discharge channel parts 222 to provide the discharge channels 230, a plurality of channel dividing parts 224 making contact with the first substrate 210 and being formed between adjacent discharge channel parts 222, and a sealing part 226 formed along the outer edges of the discharge channel parts 222 and the channel dividing parts 224 for being coupled to the first substrate 210.

The second substrate 220 is formed by a molding process. When a base substrate having the plate-like shape of the first substrate 210 is heated and the heated base substrate is molded, the second substrate 220 having the discharge channel parts 222, the channel dividing parts 224 and the sealing part 226 may be obtained. Alternatively, the second substrate 220 may be formed by heating the base substrate and injecting air into the heated base substrate.

As shown in FIG. 3, a cross-sectional profile of the second substrate 220 includes a plurality of arches that are connected to one another. Although not shown in the figures, the second substrate 220 may have any cross-sectional shape other than what is depicted in FIG. 3, such as a semicircular shape, a rectangular shape, etc.

The second substrate 220 has a connection path 240 to connect adjacent discharge channels 230 to each other. Each of the channel dividing parts 224 is connected to a neighboring channel dividing part by means of at least one connection path 240. The air in the discharge channels 230 is vented through the connection path 240 or the discharge gas is injected into the discharge channels 230 through the connection path 240. The connection path 240 is formed when the second substrate 220 is formed. In the present embodiment, the connection path 240 has an “S” shape, but the connection path 240 may have any other suitable shape.

The second substrate 220 is combined with the first substrate 210 by an adhesive 250 such as a frit having a melting point lower than that of a glass. That is, the adhesive 250 is disposed between the first and second substrates 210 and 220 corresponding to the sealing part 226, and then the adhesive 250 is fired, to thereby combine the first substrate 210 with the second substrate 220. In this present embodiment, the adhesive 250 is formed only on the sealing part 226 between the first and second substrates 210 and 220, and the adhesive 250 is not formed at an area where the channel dividing parts 224 make contact with the first substrate 210. The coupling of the channel dividing parts 224 to the first substrate 210 is reinforced by a pressure difference between the inner space of the flat-type fluorescent lamp 100 and the space surrounding the flat-type fluorescent lamp 100.

When the first and second substrates 210 and 220 are coupled to each other and the air in the discharge channels 230 is vented through the venting tip 300, a vacuum forms in the inner space of the lamp body 200. The vacuum is then filled by injecting various discharge gases into the discharge channels 230 through the venting tip 300 for the plasma discharge. In the present embodiment, examples of the discharge gas may include neon (Ne), argon (Ar), xenon (Xe), krypton (Kr) and so on. After the discharge gas is injected, the venting tip 300, in which a getter having mercury (Hg) is installed, is sealed. When a high frequency is applied to the getter in the venting tip 300 to inject mercury gas into the inner space of the lamp body 200, a portion of the venting tip 300 is removed, leaving about 8 mm of the venting tip 300. In the present embodiment, a gas pressure of the inner space of the lamp body 200 is maintained at about 50 Torr to about 70 Torr below the atmospheric pressure (about 760 Torr). Due to the difference between the gas pressure of the inner space and the atmospheric pressure, force is applied to the lamp body 200 toward the inner space, reinforcing the attachment between the channel dividing parts 224 and the first substrate 210.

The venting tip 300 is attached to the outer face of the first substrate 210 on which the first external electrode 410 is formed. Also, the venting tip 300 is attached to a position corresponding to a venting hole 216 of the first substrate 210. In the present embodiment, the venting tip 300 is coupled to the first substrate 210 by means of a ring frit 310.

The first external electrode 410 is formed on the outer face of the first substrate 210. The first external electrode 410 is formed along two edges of the first substrate 210 and extend in a direction substantially perpendicular to the direction in which the discharge channel parts 222 extend, while overlapping the ends of the discharge channel parts 222. The first external electrode 410 is partially removed to form the opening 412 through which the venting tip 300 extends. This way, the flat-type fluorescent lamp prevents the strong electric field from forming between the bottom chassis (not shown) in which the flat-type fluorescent lamp 100 is received and the first external electrode 410 corresponding to the venting tip 300. The deterioration of brightness uniformity that is a problem with the conventional flat-type fluorescent lamp is thus avoided.

The first external electrode 410 includes a material having a superior conductivity. In the present embodiment, the first external electrode 410 is formed in such a manner where a silver paste having silver (Ag) and silicon oxide (SiO₂) is coated on the first substrate 210. Also, the first external electrode 410 may be formed by spraying a metal powder including at least any one of copper (Cu), nickel (Ni), silver (Ag), gold (Au), aluminum (Al) and chrome (Cr) on the first substrate 210. The flat-type fluorescent lamp 100 may further include an insulating layer (not shown) formed on an outer face of the first external electrode 410.

The flat-type fluorescent lamp 100 may further include a second external electrode 420 formed on an outer face of the second substrate 220. The second external electrode 420 is formed at a position corresponding to the first external electrode 410. The second external electrode 420 may be formed using the same materials and same processes as the first external electrode 410.

The first and second external electrodes 410 and 420 may be electrically connected to each other by means of a conductive metal clip (not shown). The first and second external electrodes 410 and 420 receive the discharge voltage applied from an external inverter (not shown). The flat-type fluorescent lamp 100 generates the plasma in every discharge channel 230 in response to the discharge voltage applied to the first and second external electrodes 410 and 420.

The lamp body 200 further includes a reflection film 212 formed on the inner face of the first substrate 210 and fluorescent films 214 and 228 formed on an upper face of the reflection film 212 and the inner face of the second substrate 220, respectively. The reflection film 212 reflects the visible light from the fluorescent films 214 and 228 to prevent leakage of the visible light through the first substrate 210. The fluorescent films 214 and 228 are divided into a first fluorescent film 214 on the inner face of the first substrate 210 and a second fluorescent film 228 on the inner face of the second substrate 220. The first and second fluorescent films 214 and 228 are excited by the ultraviolet light generated in the discharge channels 230 due to the plasma discharge and emit the visible light. The reflection film 212, the first fluorescent film 214 and the second fluorescent film 228 are sprayed on the first and second substrates 210 and 220 before the first substrate 210 is coupled to the second substrate 220. The reflection film 212 and the first fluorescent film 214 are formed over the inner face of the first substrate 210 except where the venting hole 216 is located. In some embodiments, the reflection film 212 and the first fluorescent film 214 may be formed over the first substrate 210 except an area corresponding to the venting hole 216, the channel dividing parts 224 and the sealing part 226. The second fluorescent film 228 is formed over the inner face of the second substrate 220 such that it does not overlap the channel dividing parts 224 or the sealing part 226.

The lamp body 200 may further include a protection film (not shown) between the second substrate 220 and the second fluorescent film 228 and/or between the first substrate 210 and the reflection film 212. The protection film prevents a chemical reaction between the first or the second substrate 210 and 220 and the mercury (Hg) injected into the discharge channel 230, thereby preventing loss of the mercury and blackening of the flat-type fluorescent lamp 100.

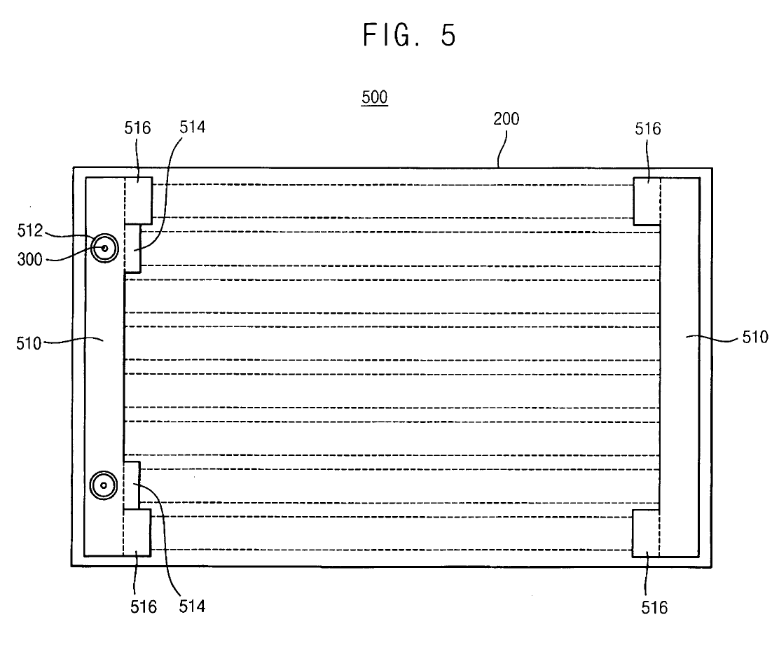

FIG. 5 is a plan view showing a flat-type fluorescent lamp according to another exemplary embodiment of the present invention. In FIG. 5, the same reference numerals denote the same elements in FIGS. 1 to 4, and thus the detailed descriptions of the same elements will be omitted.

Referring to FIG. 5, a flat-type fluorescent lamp 500 includes a lamp body 200, a venting tip 300 and a first external electrode 510.

The first external electrode 510 is formed on an outer face of the lamp body 200 on which the venting tip 300 is formed. The first external electrode 510 has an opening 512 to expose the venting tip 300.

The first external electrode 510 further includes a first compensation electrode 514. The first compensation electrode 514 extends, from the first external electrode 510, in a direction substantially perpendicular to the length of the first external electrode 510. Due to the opening 512, the first external electrode 510 overlaying the discharge channels 230 that are attached to the venting tip 300 has a smaller surface area than the first external electrode 510 overlaying the discharge channels 230 that are not attached to the venting tip 300. The discharge channels 230 near the smaller first external electrode 510 have a lower brightness level than the discharge channels 230 near the larger first external electrode 510, causing the brightness of the flat-type fluorescent lamp 500 to be non-uniform. By adding the first compensation electrode 514 to the smaller one of the first external electrode 510, the brightness of the discharge channels 230 near the smaller first external electrode 510 is enhanced. In this present embodiment, the first compensation electrode 514 has a same area as that of the opening 514, equalizing the surface area of the two first external electrodes 510.

The first external electrode 510 may further include a second compensation electrode 516 that are formed to overlap the outermost discharge channels 230. The second compensation electrode 516 extends from the first external electrode 510 in the direction substantially perpendicular to the direction in which the first external electrode 510 extends. In the present embodiment, the second compensation electrode 516 is longer than the first compensation electrode 514. The outermost discharge channels 230 may have brightness lower than that of the discharge channels 230 therebetween. The second compensation electrode 516 increases the area of the first external electrode 510 overlapping with the outermost discharge channels 230, thereby enhancing the brightness of the outermost discharge channels 230.

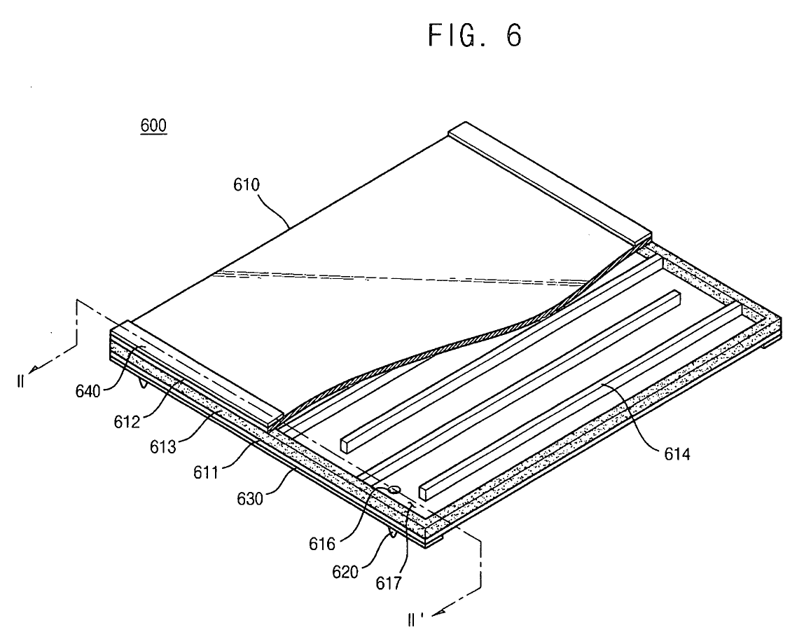

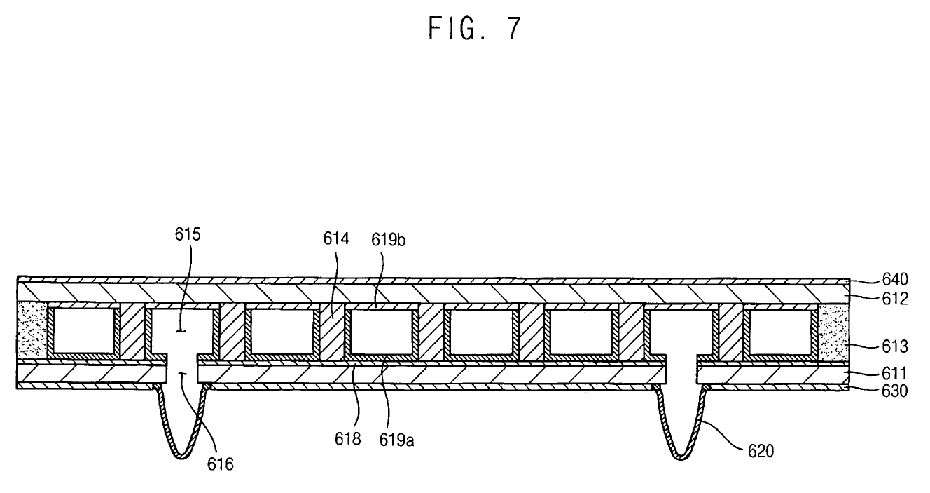

FIG. 6 is a perspective view showing a flat-type fluorescent lamp according to another exemplary embodiment of the present invention. FIG. 7 is a cross-sectional view taken along a line II-II′ of FIG. 6.

Referring to FIGS. 6 and 7, a flat-type fluorescent lamp 600 includes a lamp body 610, a venting tip 620 and a first external electrode 630.

The lamp body 610 has a first substrate 611, a second substrate 612, a sealing member 613 and a plurality of space-dividing walls 614.

Each of the first and second substrates 611 and 612 has a plate-like shape and is a transparent glass substrate that transmits visible light. The first and second substrates 611 and 612 are spaced apart from each other by a predetermined distance to provide an inner space therebetween. The first and second substrates 611 and 612 may have a blocking material to prevent the ultraviolet light in the inner space from leaking. The first substrate 611 has a venting hole 616 near the venting tip 600.

The sealing member 613 is disposed between the first and second substrates 611 and 612 to combine the first substrate 611 with the second substrate 612 and to seal the inner space between the first and second substrates 611 and 612. The sealing member 613 contains the same glass material as the first and second substrates 611 and 612. The sealing member 613 is attached to the first and second substrates 611 and 612 by means of a frit having a melting point lower than that of a glass.

The space-dividing walls 614 between the first and second substrates 611 and 612 divide the inner space between the first and second substrates 611 and 612 into a plurality of discharge channels 615. Each of the space-dividing walls 614 has a bar-like shape. The space-dividing walls 614 extend in a first direction and arranged in a second direction substantially perpendicular to the first direction. The space-dividing walls 614 are spaced apart from each other by a predetermined distance. The space-dividing walls 614 contain the same glass material as the first and second substrates 611 and 612, and are adhered to the first and second substrates 611 and 612 by means of the adhesive such as the frit. The space-dividing walls 614 may be formed by spraying a melted raw material of the space-dividing walls 614 by using a dispenser. As shown in FIG. 7, each of the space-dividing walls 614 may have a rectangular cross-sectional shape. However, the invention is not so limited and the space-dividing walls may have other cross-sectional shapes, such as a generally rectangular shape, a trapezoid shape, an oval shape etc.

The lamp body 610 has a connection path 617 to connect the discharge channels 615 to each other. To make the connection path 617, at least one end of each of the space-dividing walls 614 is “opened,” or spaced apart from the nearest sealing member 613. In the present embodiment, opposite ends of consecutive space-dividing walls 614 are opened in an alternating manner so that the connection path 617 has a serpentine shape. More specifically, when a first end of a first space-dividing wall among the space-dividing walls 614 is spaced apart from the sealing member 613, a second end of the next adjacent space-dividing wall that neighbors the first space-dividing wall is space apart from the sealing member 613. The first end and the second end are opposite ends of the space-dividing walls 614. In some embodiments, the connection path 617 may be formed by partially removing a segment of each of the space-dividing walls 614 while the both ends of the space-dividing walls 614 are attached to the sealing member 613.

The venting tip 620 is attached to the outer face of the first substrate 611 corresponding to the venting hole 616. The venting tip 620 has a structure and a function that are substantially similar to those of the venting tip 300 shown in FIG. 1, and thus the detailed descriptions of the venting tip 620 will be omitted.

The first external electrode 630 is formed on the outer surface of the first substrate 611 to which the venting tip 620 is attached. The first external electrode 630 has an opening near to the venting tip 620. The first external electrode 630 has a structure and a function that are substantially similar to those of the first external electrode shown in FIG. 1 or 5, and thus the detailed description of the first external electrode 630 will be omitted.

The flat-type fluorescent lamp 600 may further include a second external electrode 640 on the outer face of the second substrate 612. Furthermore, the flat-type fluorescent lamp 600 may further include a reflection film 618 formed on an inner face of the first substrate 611, a first fluorescent film 619a on an upper face of the reflection film 618 and side faces of the space-dividing walls 614, and a second fluorescent film 619b on an inner face of the second substrate 612.

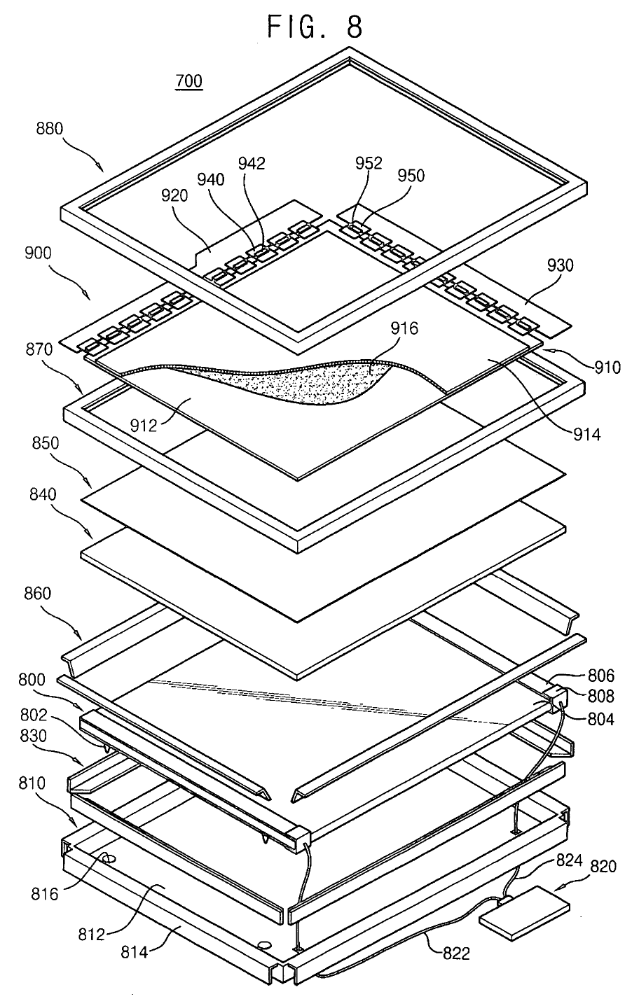

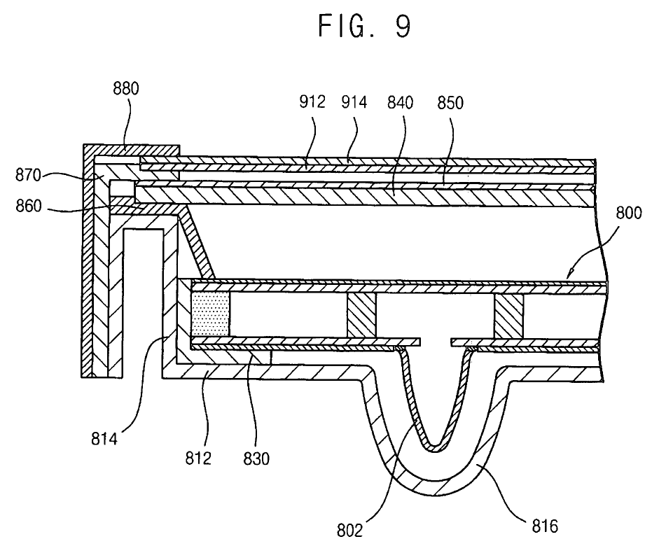

FIG. 8 is an exploded perspective view showing a liquid crystal display apparatus according to an exemplary embodiment of the present invention. FIG. 9 is a cross-sectional view showing the liquid crystal display apparatus of FIG. 8.

Referring to FIGS. 8 and 9, a liquid crystal display apparatus 700 has a flat-type fluorescent lamp 800, a bottom chassis 810, a display unit 900 and an inverter.

The flat-type fluorescent lamp 800 may have a structure and a function that are substantially similar to those of the above embodiments shown in FIGS. 1 to 7, and thus the detailed description of the flat-type fluorescent lamp 800 will be omitted.

The bottom chassis 810 has a bottom portion 812 and a side portion 814 extending from an edge of the bottom portion to provide a receiving space. The bottom chassis 810 contains a metal that is strong enough to hold the liquid crystal display apparatus 700 together. The flat-type fluorescent lamp 800 is received into the receiving space of the bottom chassis 810. Since the flat-type fluorescent lamp 800 has a venting tip 802 protruding toward the bottom portion 812 of the bottom chassis 810, the bottom chassis 810 has a protruding portion 816 corresponding to the venting tip 802.

The liquid crystal display apparatus 700 may further include a supporting member 830 between the flat-type fluorescent lamp 800 and the bottom chassis 810 to support the flat-type fluorescent lamp 100. The supporting member 830 is positioned near the edges of the flat-type fluorescent lamp 800. The flat-type fluorescent lamp 800 is spaced apart from the bottom chassis 810 by the supporting member 830, thereby preventing contact between the flat-type fluorescent lamp 800 and the bottom chassis 810. In the present embodiment, the supporting member 830 has silicon for an insulating property and elasticity.

The display unit 900 has a liquid crystal display panel 910 displaying an image using light from the flat-type fluorescent lamp 100 and a data printed circuit board 920 and a gate printed circuit board 930 applying driving signals to the liquid crystal display panel 910. The driving signals from the data and gate printed circuit boards 920 and 930 are applied to the liquid crystal display panel 910 via a data flexible printed circuit board 940 and a gate flexible printed circuit board 950, respectively. Each of the data flexible printed circuit board 940 and the gate flexible printed circuit board 950 has a tape carrier package or a chip-on-film. The data and gate flexible printed circuit boards 940 and 950 have a data driving chip 942 and a gate driving chip 952, respectively, so as to timely apply the driving signals from the data and gate printed circuit boards 920 and 930 to the liquid crystal display panel 910.

The liquid crystal display panel 910 has a thin film transistor (TFT) substrate 912, a color filter substrate 914 facing the TFT substrate 912 and liquid crystal 916 interposed between the TFT substrate 912 and the color filter substrate 914.

The TFT substrate 912 is a transparent glass substrate on which TFTs are arranged in a matrix configuration. Each of the TFTs has a source electrically connected to a data line, a gate electrically connected to a gate line, and a drain electrically connected to a pixel electrode (not shown) having a transparent conductive material.

RGB pixels (not shown), which are color pixels for emitting predetermined colors when the light passes therethrough, are formed on the color filter substrate 914 by a thin film process. The color filter substrate 914 has a common electrode (not shown) thereon. The common electrode is a transparent conductive material.

When a power is applied to the gate of the TFT, the TFT is turned on so that an electric field is generated between the pixel electrode and the common electrode. The electric field varies an aligning angle of the liquid crystal interposed between the TFT substrate 912 and the color filter substrate 914. Light transmittance through the liquid crystal layer is varied in accordance with the variation of the aligning angle of the liquid crystal. Thus, a desired image may be obtained by adjusting the electric field.

The inverter 820 is disposed outside the bottom chassis 810, and generates a discharge voltage to drive the flat-type fluorescent lamp 800. The inverter 820 receives an alternating current voltage having a low voltage level and outputs an alternating current voltage having a high voltage level. The discharge voltage from the inverter 820 is applied to an external electrode 806 of the flat-type fluorescent lamp 800 through a first power line 822 and a second power line 824. If the external electrode 806 is formed on upper and lower faces of a lamp body 804, the flat-type fluorescent lamp 800 may further include a conductive clip 808 to electrically connect the external electrode 806 on the upper face and the external electrode 806 on the lower face. Also, the first and second power lines 822 and 824 are electrically connected to the conductive clip 808.

The liquid crystal display apparatus 700 may further include a diffusion plate 840 and an optical sheet 850 between the flat-type fluorescent lamp 800 and the liquid crystal display panel 910. The diffusion plate 840 diffuses the light from the flat-type fluorescent lamp 800 to improve brightness uniformity of the light. The diffusion plate 840 has a plate-like shape and is spaced apart from the flat-type fluorescent lamp 800. The optical sheet 850 may have a collector sheet collecting the diffused light to enhance the brightness again.

The liquid crystal display apparatus 700 may further include a first mold 860 between the flat-type fluorescent lamp 800 and the diffusion plate 840. The first mold 860 holds the flat-type fluorescent lamp 800 and supports the diffusion plate 840. The first mold 860 is coupled to the side portion 814 of the bottom chassis 810 to fix an end of an upper face of the flat-type fluorescent lamp 800. As shown in FIG. 8, the first mold 860 may have four pieces corresponding to the four sides of the flat-type fluorescent lamp 800. In other embodiments, the first mold 860 may have an L-shaped body, a U-shaped body or a rectangular frame-like body.

The liquid crystal display apparatus 700 may further include a second mold 870 between the optical sheet 850 and the liquid crystal display panel 910. The second mold 870 fixes the optical sheet 850 and the diffusion sheet 840 to the bottom chassis 810 and supports the liquid crystal display panel 910. The second mold 870 may have the same shape as those of the first mold 860.

The liquid crystal display apparatus 700 further includes a top chassis 880 to fix the liquid crystal display panel 910 to the bottom chassis 810. The top chassis 880, which partially covers the ends of the liquid crystal display panel 910, is coupled to the bottom chassis 810 to fix the liquid crystal display panel 910 to the upper of the second mold 870. The top chassis 880 prevents damage to the liquid crystal display panel 910 and separation of the liquid crystal display panel 910 from the second mold 870.

According to the flat-type fluorescent lamp and the liquid crystal display apparatus, the portion of the external electrode near the venting tip is removed to maintain a uniform electric field between the bottom chassis and the external electrode. Also, the compensation electrode is formed to have the area that is about equal to the area of the removed external electrode. This way, the brightness uniformity of the flat-type fluorescent lamp may be improved.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A flat-type fluorescent lamp comprising:
a lamp body having an inner space divided into a plurality of discharge channels;
a venting member formed on the lamp body; and
a first external electrode formed on the lamp body, the first external electrode having an opening through which the venting member is exposed.

2. The flat-type fluorescent lamp of claim 1, wherein the first external electrode has a substantially uniform width except for an area at which the opening is formed.

3. The flat-type fluorescent lamp of claim 1, wherein the first external electrode further comprises a compensation electrode extending in a first direction that is substantially perpendicular to a second direction in which the first external electrode extends.

4. The flat-type fluorescent lamp of claim 1, wherein the lamp body comprises:
a first substrate; and
a second substrate combined with the first substrate to provide the inner space therebetween.

5. The flat-type fluorescent lamp of claim 4, wherein the venting member is attached to the first substrate.

6. The flat-type fluorescent lamp of claim 4, wherein the second substrate comprises:
a plurality of discharge channel parts spaced apart from the first substrate to form discharge channels;
a plurality of channel dividing parts contacted with the first substrate and formed between the discharge channel parts; and
a sealing part formed at outer edges of the discharge channel parts and the channel dividing parts and coupled to the first substrate.

7. The flat-type fluorescent lamp of claim 4, wherein the lamp body further comprises a plurality of space-dividing walls between the first and second substrates to divide the inner space into the discharge channels.

8. The flat-type fluorescent lamp of claim 4, further comprising a second external electrode formed on an outer surface of the second substrate corresponding to the first external electrode.

9. The flat-type fluorescent lamp of claim 4, wherein the lamp body further comprises:
a reflection film formed on an inner surface of the first substrate; and
a fluorescent film formed on an upper surface of the reflection film and an inner surface of the second substrate.

10. A liquid crystal display apparatus comprising:
a flat-type fluorescent lamp comprising:
a lamp body having an inner space divided into a plurality of discharge channels;
a venting member formed on the lamp body; and
a first external electrode formed on the lamp body, the first external electrode having an opening through which the venting member is exposed, a bottom chassis receiving the flat-type fluorescent lamp;
a liquid crystal display panel displaying an image using light emitted from the flat-type fluorescent lamp; and
an inverter to generate a discharge voltage driving the flat-type fluorescent lamp.

11. The liquid crystal display apparatus of claim 10, wherein the first external electrode has a substantially uniform width except for an area at which the opening is formed.

12. The liquid crystal display apparatus of claim 11, wherein the first external electrode further comprises a compensation electrode extending in a first direction that is substantially perpendicular to the second direction in which the first external electrode extends.

13. The liquid crystal display apparatus of claim 10, wherein the bottom chassis comprises a protrusion corresponding to the venting member that protrudes outward.

14. The liquid crystal display apparatus of claim 10, wherein the lamp body comprises:
a first substrate; and
a second substrate comprising:
a plurality of discharge channel parts spaced apart from the first substrate to form the discharge channels;
a plurality of channel dividing parts contacted with the first substrate and formed between the discharge channel parts; and
a sealing part formed at outer edges of the discharge channel parts and the channel dividing parts and coupled to the first substrate.

15. The liquid crystal display apparatus of claim 14, wherein the venting member is attached to the first substrate, and
the first external electrode is formed on an outer surface of the first substrate.

16. The liquid crystal display apparatus of claim 15, wherein the flat-type fluorescent lamp further comprises a second external electrode formed on an outer surface of the second substrate corresponding to the first external electrode.

17. The liquid crystal display apparatus of claim 10, further comprising a supporting member between the flat-type fluorescent lamp and the bottom chassis to support the flat-type fluorescent lamp.

18. The liquid crystal display apparatus of claim 17, further comprising:
a diffusion plate between the flat-type fluorescent lamp and the liquid crystal display panel;
an optical sheet on the diffusion plate; and
a top chassis to fix the liquid crystal display panel to the bottom chassis.
